(19) United States
(12) Patent Application Publication
(10) Pub. No.: US 2012/0090652 A1
(43) Pub. Date: Apr. 19, 2012

(54) CLEANING APPARATUS FOR SOLDER PASTE IN APERTURES

(75) Inventors: Hao-Chun HSIEH, Taipei Hsien (TW); Hsin-Lun Tasi, Taipei Hsien (TW); Chia-Hsien Lee, Taipei Hsien (TW)

(73) Assignee: Wistron Corporation, Taipei Hsien (TW)

(21) Appl. No.: 13/113,495

(22) Filed: May 23, 2011

(30) Foreign Application Priority Data
Oct. 14, 2010 (TW) 099135038

(51) Int. Cl. B08B 5/02

(52) U.S. Cl. 134/198

(57) ABSTRACT

The cleaning apparatus for solder paste in apertures according to the present invention comprises a stencil, a guiding plate, and a blower. The stencil has a plurality of apertures with residual solder paste on the sidewalls thereof. The guiding plate is disposed above the stencil and has a plurality of wind-guiding pillars and a plurality of wind-guiding holes. The locations of the wind-guiding pillars are opposite to the locations of the apertures; the wind-guiding holes are located around the wind-guiding pillars. The blower is disposed above the guiding plate and provides a gas to the guiding plate. The gas is guided into the apertures by means of the wind-guiding pillars and the wind-guiding holes and pushes completely the solder paste therein out. Thereby, accumulation of solder paste in the sidewalls of the apertures can be avoided. Consequently, deterioration of adhesion of electronic components caused by fewer amount of solder paste printed on the carrier can be prevented.

### FIELD OF THE INVENTION

The present invention relates generally to a cleaning apparatus, and particularly to a cleaning apparatus for solder paste in apertures.

### BACKGROUND OF THE INVENTION

Nowadays, electronic products are designed toward the trend of lightness and compactness for satisfying consumers' demand in mobility. Thereby, passive components are shrunk from the size 0402 and 0201 to 01005, which is currently the smallest size for passive components. The size of a 01005 component is 0.4 mm×0.2 mm, and the corresponding aperture in the stencil is a circle with a diameter of 0.19 mm. Such a small component and aperture in stencil cannot be observed visually, hence bringing about many challenges in production. Consequently, few 01005 components are used in the market at present.

According to experiments, one of the problems in production using 01005 components is the solder residue in the apertures of the stencil. The solder residues in apertures affects solder paste deposition of the stencil, and thus leading to severe production defects caused by tin deficiency. Some foreign researches also mentioned the severity of solder residues and aperture obstruction. It is shown that 49% of defects in using 01005 components is caused by printing machines.

FIG. 1 shows a structural schematic diagram of a printing apparatus of solder past according to prior art. As shown in the figure, printing technology for solder paste is a general adhesion technology applied between a carrier, such as a circuit board or a substrate, and electronic components. The printing apparatus of solder paste at present is shown in FIG. 1. A stencil 12 is disposed in a frame-shaped fixing assembly 10. The stencil 12 has a plurality of apertures 122. A scraper 14 capable of moving horizontally is assembled above the stencil 12. When solder paste is to be printed onto the carrier 16, the carrier 16 is loaded to the bottom of the stencil 12 and the solder paste is spread on the surface of the stencil 12. Then scrape the scraper horizontally over the stencil 12 for squeezing the solder paste into the apertures 122.

Nonetheless, as electronic products are manufactured more compactly and finely, the area of the carrier 16 tends to shrink, and hence engendering bottleneck in printing solder paste. As the area of the carrier 16 shrinks, the pitch of on the stencil 12 shrinks and the aspect ratio of aperture, namely, the ratio of aperture depth to diameter, increases. Thereby, when the carrier 16 escapes from the stencil 12, the viscous force between the solder paste and the carrier 16 cannot overcome the viscous force between the solder paste and sidewalls of the apertures 122, and thus producing the solder residues due to inability of the solder paste escaping from the apertures 122. When the solder residues accumulate, the amount of solder paste printed to the carrier 16 decreases, and thereby deteriorating soldering reliability and adhesion of electronic components.

It is known from above that the solder residue phenomenon is an inevitable consequence and has to be eliminated. Currently, there are two methods for cleaning solder residues in the stencil 12. One uses cleaning wheels to roll at the bottom of the stencil 12 for cleaning; the other adopts a cleaning cloth in coordination with vacuuming for cleaning solder residues. However, no matter the cleaning wheels or the cleaning cloth in coordination with vacuuming, the solder residues on the sidewalls of the apertures 122 cannot be accessed and thereby cleaned, leading to inferior cleaning result and thus affecting subsequent solder paste printing.

FIG. 2 shows a structural schematic diagram of another printing apparatus of solder past according to prior art. As shown in the figure, in order to eliminate the solder residues in the stencil 12 with more efficiency, according to the prior art, wind knives 142 are disposed on both sides of the scraper 14. When the scraper 14 moves horizontally on the stencil 12, the stencil 12 will be pressed downwards close to the top surface of the carrier 16 while stuffing solder paste firmly in the apertures 122 and to the top surface of the carrier 16. After the press by the scraper 14, the part of the stencil 12 returns to the original height with some solder residues left in the apertures 122. At this moment, the wind knives 142 located on sides of the scraper 14 eject high-speed airflows to the sidewalls of the apertures 122 and blow away the solder residues adhered thereon. Consequently, the sidewalls of the apertures 122 can be kept clean, facilitating integrity of solder paste for the next printing. Nevertheless, because the apertures 122 are too small, the air blown by the wind knives 142 cannot blow away the solder paste completely, and hence leaving some solder paste accumulated on the sidewalls of the apertures 122.

Accordingly, the present invention provides a cleaning apparatus for solder paste in apertures, which can avoid accumulation of solder paste on the inner sidewalls of the apertures. Consequently, deterioration of soldering reliability and adhesion of electronic components caused by fewer amount of solder paste printed on the carrier can be prevented.

### SUMMARY

An objective of the present invention is to provide a cleaning apparatus for solder paste in apertures, which uses a plurality of wind-guiding pillars to guide a gas to a plurality of apertures such that the gas flows into the apertures and pushes the solder paste in the apertures out. Thereby, accumulation of solder paste in the sidewalls of the apertures can be avoided. Consequently, deterioration of adhesion of electronic components caused by fewer amount of solder paste printed on the carrier can be prevented.

Another objective of the present invention is to provide a cleaning apparatus for solder paste in apertures, which uses a blower to provide a gas and a plurality of wind-guiding holes to push solder paste out of the apertures by the gas. Thereby, accumulation of solder paste in the sidewalls of the apertures can be avoided. Besides, the situation of fewer amount of solder paste printed on the carrier can be prevented.

The cleaning apparatus for solder paste in apertures according to the present invention comprises a stencil, a guiding plate, and a blower. The stencil has a plurality of apertures with residual solder paste on the sidewalls thereof. The guiding plate is disposed above the stencil and has a plurality of wind-guiding pillars and a plurality of wind-guiding holes. The locations of the wind-guiding pillars are opposite to the locations of the apertures; the wind-guiding holes are located around the wind-guiding pillars. The blower is disposed above the guiding plate and provides a gas to the guiding plate. The gas is guided into the apertures by means of the wind-guiding pillars and the wind-guiding holes and pushes the solder paste therein out. Thereby, accumulation of solder paste in the sidewalls of the apertures can be avoided. Consequently, deterioration of adhesion of electronic components caused by fewer amount of solder paste printed on the carrier can be prevented.

### BRIEF DESCRIPTION OF THE DRAWINGS

FIG. 1 shows a structural schematic diagram of a printing apparatus of solder past according to prior art;

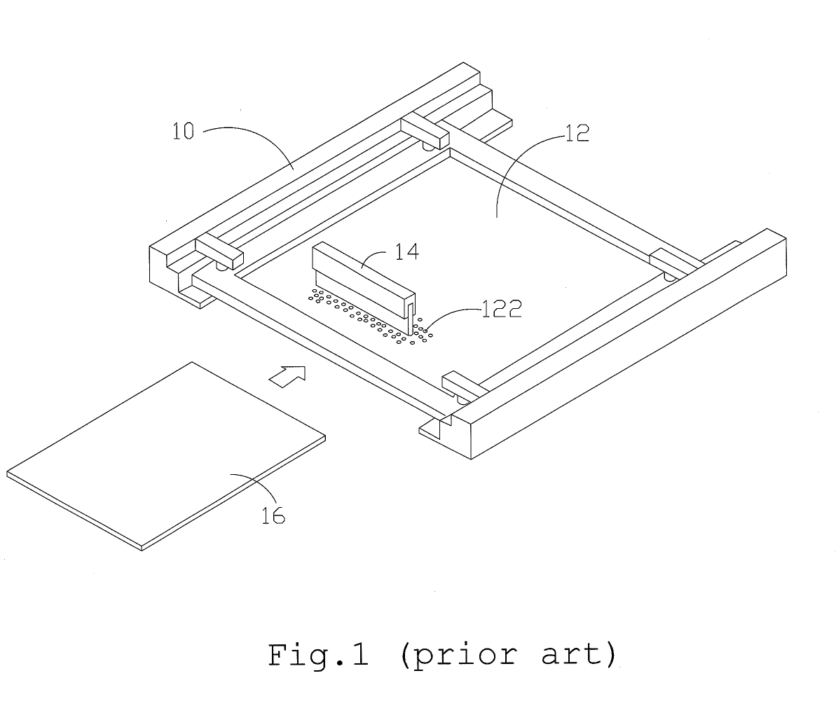

FIG. 2 shows a structural schematic diagram of another printing apparatus of solder past according to prior art;

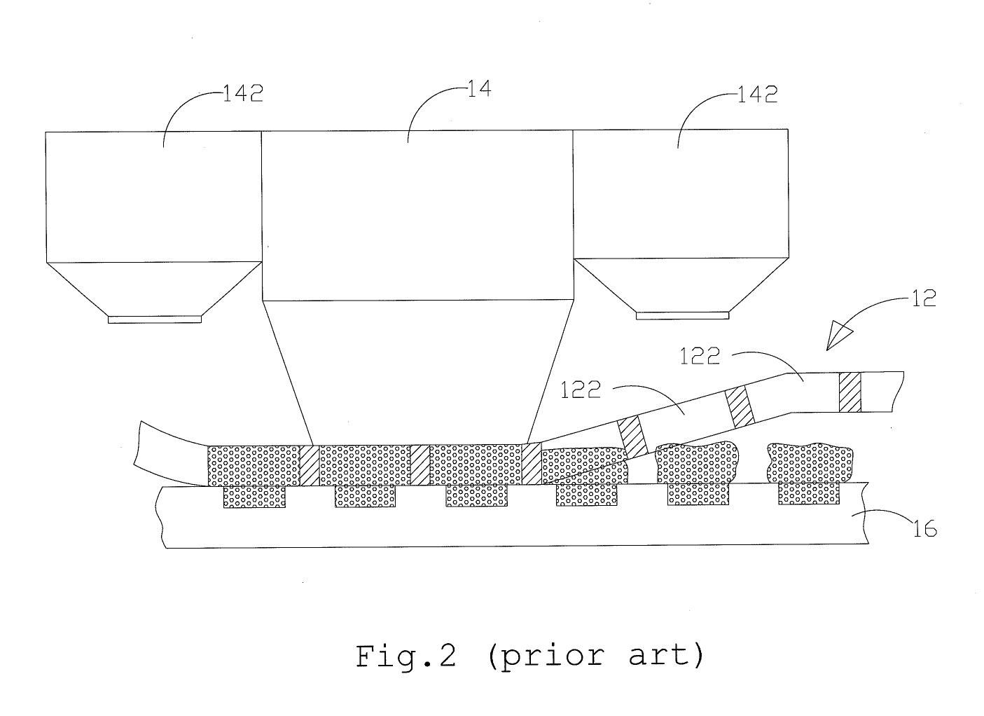

FIG. 3A shows a structural schematic diagram of a cleaning apparatus for solder paste in apertures according to a preferred embodiment of the present invention;

FIG. 3B shows locations of wind-guiding holes and apertures according to a preferred embodiment of the present invention;

FIG. 3C shows a structural schematic diagram of a cleaning apparatus for solder paste in apertures according to another preferred embodiment of the present invention;

FIG. 4A shows a structural schematic diagram of a cleaning apparatus for solder paste in apertures according to another preferred embodiment of the present invention;

FIG. 4B shows a structural schematic diagram of a cleaning apparatus for solder paste in apertures according to another preferred embodiment of the present invention;

FIG. 5A shows a structural schematic diagram of a cleaning apparatus for solder paste in apertures according to another preferred embodiment of the present invention; and

FIG. 5B shows a structural schematic diagram of a cleaning apparatus for solder paste in apertures according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

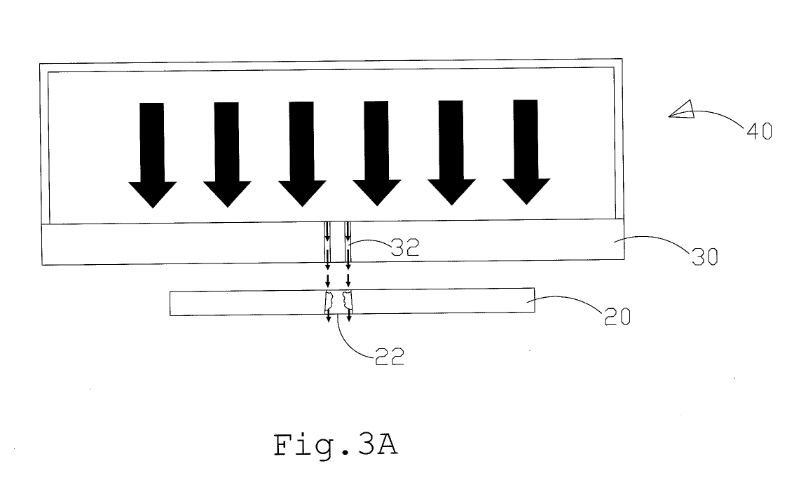

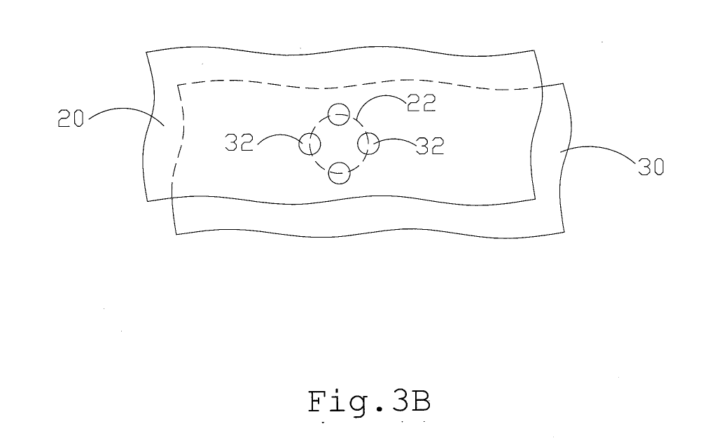

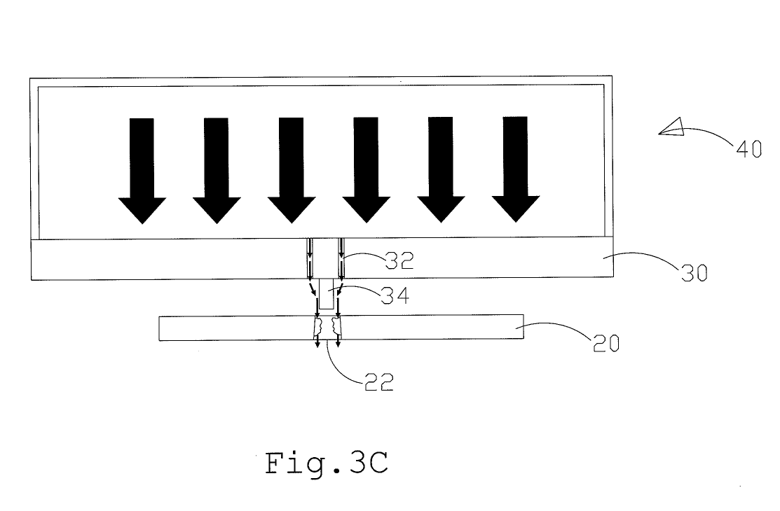

FIG. 3A shows a structural schematic diagram of a cleaning apparatus for solder paste in apertures according to a preferred embodiment of the present invention. As shown in the figure, the cleaning apparatus for solder paste in apertures according to the present invention comprises a stencil 20, a guiding plate 30, and a blower 40. The stencil 20 has a plurality of apertures 22 with residual solder paste on the sidewalls thereof. The guiding plate 30 is disposed above the stencil 20 and has a plurality of wind-guiding holes 32. The locations of the wind-guiding holes 32 are opposite to the perimeters of the apertures 22. The radius of the wind-guiding holes 32 is smaller than the diameter of the apertures 22. The blower 40 is disposed above the guiding plate 30 and provides a gas to the guiding plate 30. The gas flows into the wind-guiding holes 32 and is guided to the edge locations of the apertures 22, and thus pushing the solder paste out of the inner sidewalls of the apertures 22. By using the wind-guiding holes 32 to guide the gas to the edge locations of the apertures 22, when the gas flows into the apertures, the solder paste can be pushed completely out of the inner sidewalls of the apertures 22. Thereby, accumulation of solder paste in the sidewalls of the apertures can be avoided. Consequently, deterioration of adhesion of electronic components caused by fewer amount of solder paste printed on the carrier 16 can be prevented.

FIG. 3B shows locations of wind-guiding holes and apertures according to a preferred embodiment of the present invention. As shown in the figure, the locations of the wind-guiding holes 32 are opposite to the perimeter of the aperture 22. The plurality of wind-guiding holes 32 are located surround the perimeter of the aperture 22. In addition, the size of the wind-guiding holes 32 is much smaller than that of the aperture 22. Thereby, when the gas is guided into the aperture 22, it is easier for the gas to flow into the perimeter of the aperture, and thus facilitating pushing completely the solder paste out of the aperture 22.

FIG. 3C shows a structural schematic diagram of a cleaning apparatus for solder paste in apertures according to another preferred embodiment of the present invention. As shown in the figure, the difference between the present embodiment and the one in FIG. 3B is that the present embodiment further comprises a plurality of wind-guiding pillars 34 disposed on the guiding plate 30. The locations of the wind-guiding pillars are opposite to the locations of the apertures 22. Besides, the wind-guiding holes 32 are located surround the wind-guiding pillars 34. The radius of the wind-guiding pillars 34 according to the present invention is smaller than the diameter of the plurality of apertures 22. Thereby, when the blower 40 provides the gas to the guiding plate 30, the gas flows into the wind-guiding holes 32 and then flows past the perimeters of the wind-guiding pillars 34 for guiding the gas to flow to the perimeters of the aperture 22 and pushing the solder paste completely out of the inner sidewalls of the apertures 22. Thereby, accumulation of solder paste in the sidewalls of the apertures 22 can be avoided. Consequently, deterioration of adhesion of electronic components caused by fewer amount of solder paste printed on the carrier 16 can be prevented.

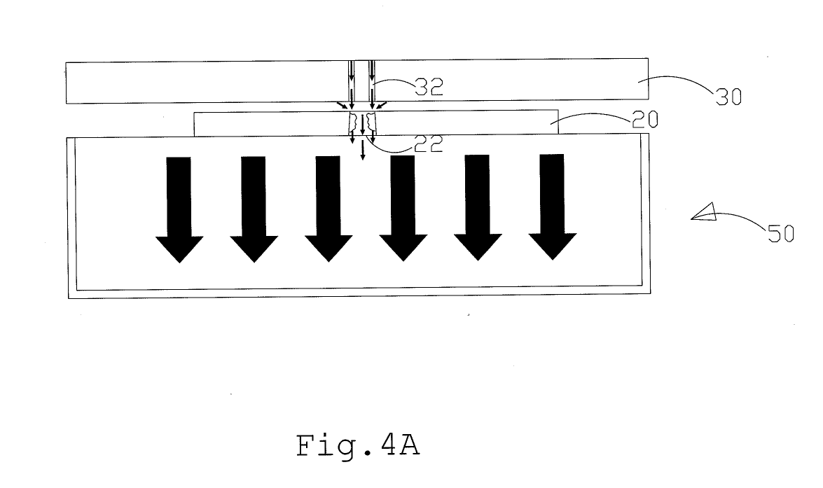

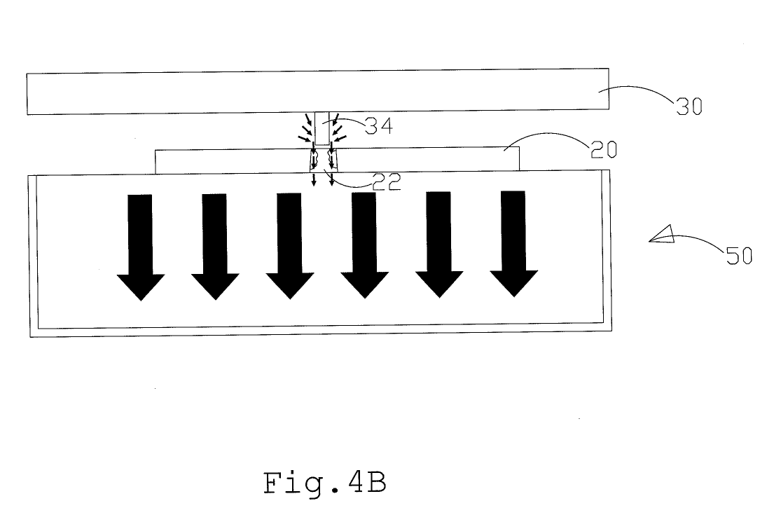

FIG. 4A and FIG. 4B show structural schematic diagrams of a cleaning apparatuses for solder paste in apertures according to other preferred embodiments of the present invention. As shown in the figures, in addition to the stencil 20 and the guiding plate 30, the embodiments in FIGS. 4A and 4B further comprise a suction apparatus 50. However, the guiding plate 30 of the embodiment in FIG. 4A has a plurality of wind-guiding holes 32 only, not including the wind-guiding pillars 34. The suction apparatus 50 sucks a gas such that the gas flows downwards via the top of the stencil 20. The gas is guided by the wind-guiding holes 32 to the perimeters of the apertures 22. Thereby, the gas can flow along the inner sidewalls of the apertures 22, and thus pushing solder paste out of the inner sidewalls of the apertures 22.

On the other hand, the guiding plate 30 of the embodiment in FIG. 4B has a plurality of wind-guiding pillars 34 only, not including the wind-guiding holes 32. The locations of the wind-guiding pillars 34 are opposite to those of the apertures 22. The suction apparatus 50 sucks a gas such that the gas flows downwards via the top of the stencil 20. The gas is guided from the perimeters of the wind-guiding pillars 34 to the perimeters of the apertures 22, pushing solder paste out of the apertures 22, and then going into the suction apparatus 50. Thereby, the gas can flow along the inner sidewalls of the apertures 22, and thus pushing solder paste out of the inner sidewalls of the apertures 22.

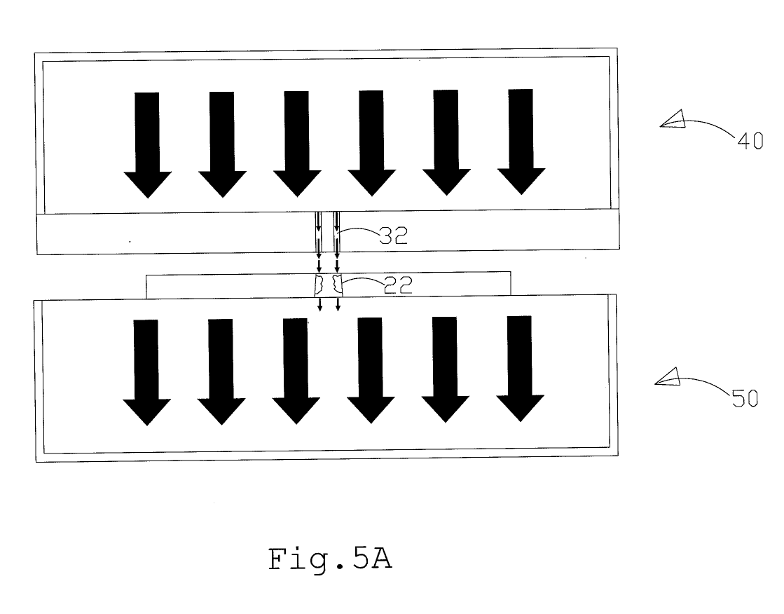

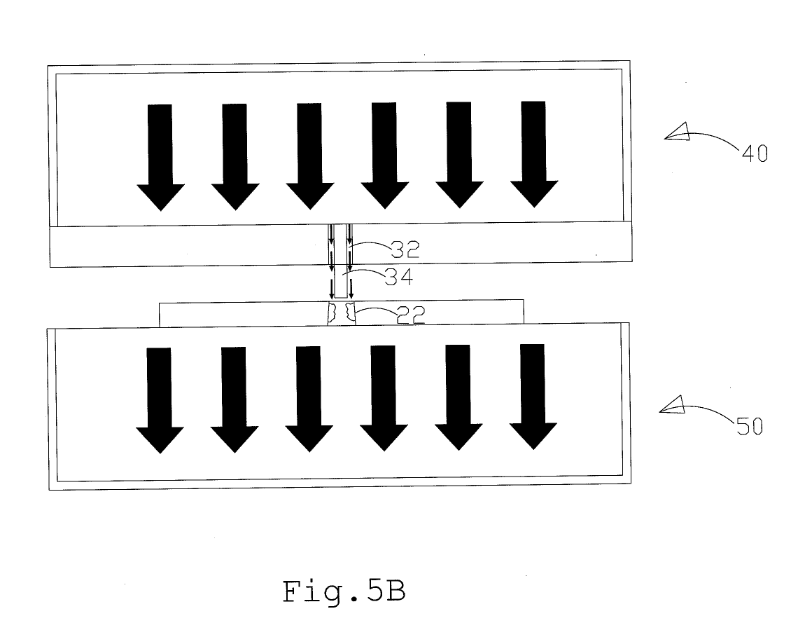

FIG. 5A and FIG. 5B show structural schematic diagrams of a cleaning apparatuses for solder paste in apertures according to other preferred embodiments of the present invention. As shown in the figures, in order to enhance the cleaning efficiency for the solder paste in the apertures 22, the flow rate of the gas is increased according to the present invention. Accordingly, the embodiments in FIGS. 5A and 5B comprise simultaneously the suction apparatus 50 and the blower 40. After the gas is supplied by the blower 40, it is absorbed rapidly by the suction apparatus 50. Thereby, the flow rate at which the gas flows through the wind-guiding holes 32 and the wind-guiding pillars 34 is increased, and hence the cleaning efficiency for the solder paste in the apertures 22 is enhanced.

To sum up, the cleaning apparatus for solder paste in apertures according to the present invention comprises a stencil, a guiding plate, and a blower. The stencil has a plurality of apertures with residual solder paste on the sidewalls thereof. The guiding plate is disposed above the stencil and has a plurality of wind-guiding pillars and a plurality of wind-guiding holes. The blower is disposed above the guiding plate and provides a gas to the guiding plate. The gas is guided into the apertures by means of the wind-guiding pillars and the wind-guiding holes and pushes completely the solder paste therein out. Thereby, accumulation of solder paste in the sidewalls of the apertures can be avoided. Consequently, deterioration of adhesion of electronic components caused by fewer amount of solder paste printed on the carrier can be prevented.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A cleaning apparatus for solder paste in apertures, comprising:
a stencil, having a plurality of apertures with residual solder paste left on the sidewalls of said apertures;
a guiding plate, disposed above said stencil, having a plurality of wind-guiding holes opposite to the perimeters of said plurality of apertures; and
a blower, disposed above said guiding plate, providing a gas to said guiding plate, said gas flowing into said plurality of wind-guiding holes and guided to said plurality of apertures, and said gas flowing into said plurality of apertures and pushing said solder paste out of said apertures.

2. The cleaning apparatus for solder paste in apertures of claim 1, wherein the radius of said plurality of wind-guiding holes is smaller than the diameter of said plurality of apertures.

3. The cleaning apparatus for solder paste in apertures of claim 1, wherein said wind-guiding plate further comprises a plurality of wind-guiding pillars opposite to said plurality of apertures and surrounded by said plurality of wind-guiding holes, said gas flowing into said plurality of wind-guiding holes and past the perimeters of said plurality of wind-guiding pillars and guided into said plurality of apertures, and said solder paste in said plurality of apertures being blown away by the thrust of said gas.

4. The cleaning apparatus for solder paste in apertures of claim 3, wherein the radius of said plurality of wind-guiding pillars is smaller than the diameter of said plurality of apertures.

5. A cleaning apparatus for solder paste in apertures, comprising:
a stencil, having a plurality of apertures with residual solder paste left on the sidewalls of said apertures;
a guiding plate, disposed above said stencil, having a plurality of wind-guiding holes opposite to the perimeters of said plurality of apertures; and
a suction apparatus, sucking a gas, said gas flowing into said plurality of wind-guiding holes and guided to said plurality of apertures, and said gas flowing into said plurality of apertures and pushing said solder paste out of said apertures.

6. The cleaning apparatus for solder paste in apertures of claim 5, wherein the radius of said plurality of wind-guiding holes is smaller than the diameter of said plurality of apertures.

7. The cleaning apparatus for solder paste in apertures of claim 5, wherein said wind-guiding plate further comprises a plurality of wind-guiding pillars opposite to said plurality of apertures and surrounded by said plurality of wind-guiding holes, said gas flowing into said plurality of wind-guiding holes and past the perimeters of said plurality of wind-guiding pillars and guided into said plurality of apertures, and said solder paste in said plurality of apertures being blown away by the thrust of said gas.

8. The cleaning apparatus for solder paste in apertures of claim 7, wherein the radius of said plurality of wind-guiding pillars is smaller than the diameter of said plurality of apertures.

9. A cleaning apparatus for solder paste in apertures, comprising:
a suction apparatus, sucking a gas;
a stencil, disposed above said suction apparatus, having a plurality of apertures with residual solder paste left on the sidewalls of said apertures, and said gas flowing via said plurality of apertures;
a guiding plate, disposed above said stencil, having a plurality of wind-guiding holes opposite to the perimeters of said plurality of apertures; and
a blower, disposed above said guiding plate, providing said gas to said guiding plate, said gas flowing into said plurality of wind-guiding holes and guided to said plurality of apertures, said gas flowing into said plurality of apertures and pushing said solder paste out of said apertures, and said gas being absorbed via said suction apparatus.

10. The cleaning apparatus for solder paste in apertures of claim 9, wherein the radius of said plurality of wind-guiding holes is smaller than the diameter of said plurality of apertures.

11. The cleaning apparatus for solder paste in apertures of claim 9, wherein said wind-guiding plate further comprises a plurality of wind-guiding pillars opposite to said plurality of apertures and surrounded by said plurality of wind-guiding holes, said gas flowing into said plurality of wind-guiding holes and past the perimeters of said plurality of wind-guiding pillars and guided into said plurality of apertures, and said solder paste in said plurality of apertures being blown away by the thrust of said gas.

12. The cleaning apparatus for solder paste in apertures of claim 11, wherein the radius of said plurality of wind-guiding pillars is smaller than the diameter of said plurality of apertures.
